(19) United States
(12) Patent Application Publication
(10) Pub. No.: US 2010/0039323 A1
(43) Pub. Date: Feb. 18, 2010

(54) METHOD AND SYSTEM FOR GLOBAL POSITION REFERENCE MAP (GPRM) FOR AGPS

(76) Inventors: Andrei Kosolobov, San Jose, CA (US); David Albert Lundgren, Mill Valley, CA (US); Steven Malkos, San Jose, CA (US)

Correspondence Address: MCANDREWS HELD & MALLOY, LTD, 500 WEST MADISON STREET, SUITE 3400, CHICAGO, IL, 60661, US

(21) Appl. No.: 12/190,192

(22) Filed: Aug. 12, 2008

(51) Int. Cl. G01S 1/00

(52) U.S. Cl. 342/357.13

(57) ABSTRACT

Aspects of a method and system for global position reference map (GPRM) for AGPS are provided. A GPS enabled device may transmit reference location data to a location server and responded with a global position reference map (GPRM) from the location server. The reference location data and/or the received GPRM may comprise reference positions, which may be any identifiable location information, for the GPS enabled device. The reference location data may be formatted via various location identifiers such as a RNC ID, MCC and/or a MNC indicating desired coverage areas for the received GPRM. The reference location data may be a portion of a reference position database inside the GPS enabled device. The reference position database may be updated via the received GPRM. A fast position fix for the GPS enabled device may be achieved by combining AGPS data or LTO AGPS data, and the reference position database.

### CROSS-REFERENCE TO RELATED APPLICATIONS/INCORPORATION BY REFERENCE

Not applicable

### FIELD OF THE INVENTION

Certain embodiments of the invention relate to signal processing for satellite navigation systems. More specifically, certain embodiments of the invention relate to a method and system for global position reference map (GPRM) for AGPS.

### BACKGROUND OF THE INVENTION

The market for location-based services (LBS) is potentially tremendous. One of the driving forces behind the LBS market is the integration of a satellite navigation receiver like a GPS receiver into a handset device such as a wireless mobile phone. The integrated GPS receiver has to quickly acquire a position fix and operate in harsh signal propagation environments with low power consumption. These requirements and the availability of various wireless connections themselves have triggered a solution called Assisted GPS (AGPS). AGPS uses assistance data to speed up the process of acquiring the position fix especially in a weak signal environment as compared to stand-alone GPS. At the same time, it may also reduce the consumption of the receiver resources (battery power and CPU time) by delegating some of the tasks to an external entity.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for global position reference map (GPRM) for AGPS, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a diagram illustrating an exemplary assistance GPS satellite navigation system, in accordance with an embodiment of the invention.

FIG. 2 is a diagram illustrating an exemplary GPS enabled handset, in accordance with an embodiment of the invention.

FIG. 3 is an exemplary call flow illustrating a reference position learning procedure, in accordance with an embodiment of the invention.

FIG. 4 is an exemplary flow chart for fast determining a position fix for a GPS enabled handset, in accordance with an embodiment of the invention.

### DETAILED DESCRIPTION OF THE INVENTION

Certain embodiments of the invention may be found in a method and system for global position reference map (GPRM) for AGPS. Various aspects of the invention may enable a remote GPS enabled device may transmit reference location data to a location server coupled to a telecommunication network. The location server may determine a global position reference map (GPRM) based on the received reference location data from the GPS enabled device. In return, the GPS enabled device may receive the determined GPRM from the location server. The reference location data and/or the determined GPRM may comprise a plurality of reference positions for the GPS enabled device. The reference positions may comprise latitude and/or longitude (LAT/LON) of surrounding base stations, WiFi towers, and/or WiMAX towers, FM stations, TV antenna, and/or other means of identifiable location information. Corresponding data for the reference location may be formatted in various ways, for example, via various technology specific location identifiers such as a Cell-ID, a RNC ID, mobile network code (MNC), and/or mobile country code (MCC). The location identifiers may provide desired coverage area information required for the determined GPRM. The location server may retrieve and generate a GPRM specifically for a particular coverage area indicated by a location identifier in the received reference location data from the GPS enabled device. The reference location data may be at least a portion of a reference position database inside the GPS enabled device. The reference position database may be updated via storing the reference position information from the received GPRM and/or tracking regional reference location changes. A fast position fix for the GPS enabled device may be determined based on AGPS data or LTO AGPS data, and the reference position database, even without a network connection with valid LTO AGPS data.

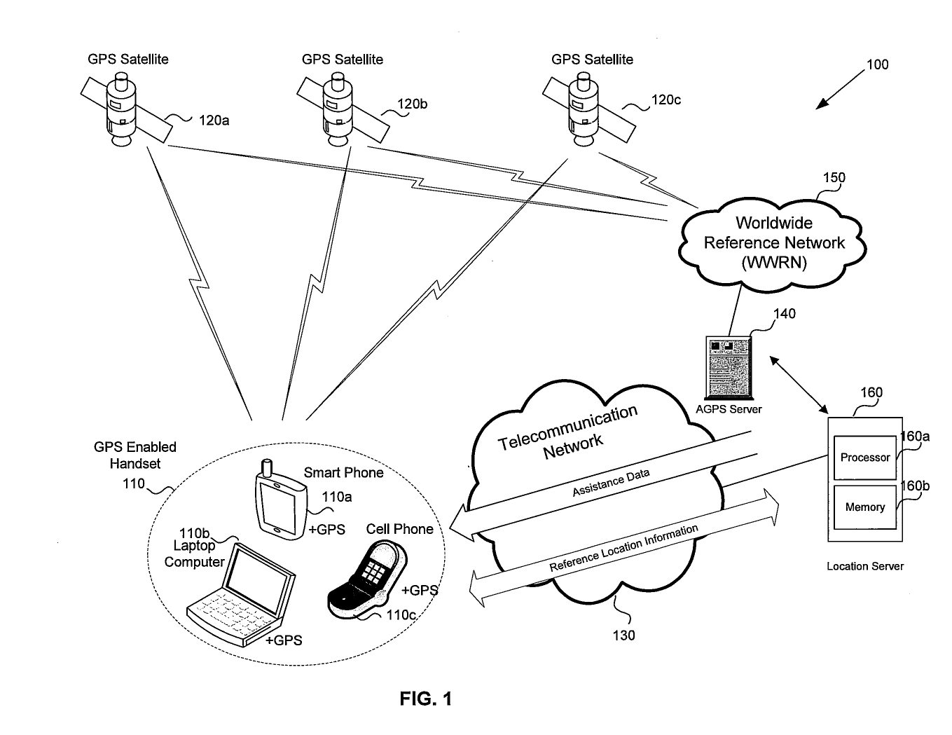

FIG. 1 is a diagram illustrating an exemplary assistance GPS satellite navigation system, in accordance with an embodiment of the invention. Referring to FIG. 1, there is shown an AGPS satellite navigation system 100, comprising a GPS enabled handset 110, a plurality of satellites, of which satellites 120a, 120b, and 120c are illustrated, an operator network 130, an AGPS server 140, a WWRN 150 and a location server 160. The location server 160 may comprise a processor 160a and a memory 160b.

The GPS enabled handset 110 may comprise suitable logic circuitry and/or code that may be enabled to receive satellite transmission signals from the GPS satellites 120a through 120c to determine the position of the GPS enabled handset 110. The GPS enabled handset 110 may be capable of transmitting and/or receiving radio signals across the operator network 130 such as, for example, 3GPP, 3GPP2, WiFi, and WiMAX. The GPS enabled handset 110 may be enabled to collect surrounding reference location information such as, for example, WiFi locations, WiMAX locations, FM stations, TV antenna, and other means of identifiable location information, and store into a reference position database created inside the GPS enabled handset 110. These stored reference location information may be subsequently utilized as initial reference positions to provide rough estimated LAT/LON for AGPS calculations. The reference position database may be updated by keeping track of surrounding reference locations and/or by communicating reference location information between the GPS enabled handset 110 and the location server 160.

The GPS enabled handset 110 may upload at least a portion of the reference position database to the location server 160 and may receive a response comprising a global position reference map (GPRM) generated at the location server 160. The GPRM may comprise various reference location information from a plurality of devices associated with the location server 160, in addition to the GPS enabled handset 110. The GPS enabled handset 110 may immediately learn from the received GPRM about the reference locations in the current area and/or surrounding areas. Moreover, the GPS enabled handset 110 may be allowed to request reference location information in a particular area. For example, the GPS enabled handset 110 may send a location identifier such as, for example, a Cell-ID, a RNC (Radio Network Controller), a MNC (Mobile Network Code), and/or a MCC (Mobile Country Code), for the particular area, in conjunction with reference location information to the location server 160.

The GPS enabled handset 110 may receive a GPRM comprising reference location information specifically for the particular area indicated by the location identifier and/or associated surrounding areas. The reference location information in the received GPRM may be stored into the reference position database to be used as reference positions for AGPS calculations. The use of the reference positions may enable the GPS enabled handset 110 to be located faster. When long term orbits (LTO) technology may be used for AGPS, a fast position fix may be achieved for the GPS enabled handset 110 by combining the LTO AGPS assistance data with the reference position database even without a continuous network connection. The reference location information may be in various formats such as, for example, Cell-ID based, RNC (Radio Network Controller) based, MNC (Mobile Network Code) based, and/or MCC (Mobile Country Code) based.

The GPS satellites 120a through 120c may comprise suitable logic, circuitry and/or code that may be enabled to generate and broadcast suitable radio-frequency signals. The broadcast RF signals may be received by a GPS satellite receiver integrated in the GPS enabled handset 110. The received broadcast RF signals may be utilized to determine a navigation information comprising, for example, position, velocity, and clock information of the GPS enabled handset 110.

The telecommunication network 130 may comprise suitable logic, circuitry and/or code that may be enabled to provide various data services on a large-scale basis by using a particular technology such as Ethernet, GSM, UMTS, WiFi, or WiMAX. The telecommunication network 130 may be a wired high-speed connection such as an Ethernet network, or may be a wireless network such as, for example, a GSM network, or a WiFi network, or a WiMAX network.

The AGPS server 140 may comprise suitable logic, circuitry and/or code that may have an access to a GPS reference network such as, for example, the WWRN 150, to collect GPS satellite data by tracking GPS constellations through the WWRN 150. The AGPS server 140 may be enabled to generate assistance data, which may be communicated to the GPS enabled handset 110 such as the cell phone 110c to compute its location. In addition, the AGPS server 140 may be enabled to use long term orbits (LTO) to supply accurate ephermeris assistance data that may be valid for, for example, up to 10 days in the future. This may enable the benefits of AGPS technology to be realized by the GPS enabled handset 110 when the GPS enabled handset 110 may temporarily be out of operator network range. The AGPS server 140 may message in exemplary formats compatible with telecommunication networks such as GSM/UMTS, and/or WiFi, and/or WiMAX. For example, the AGPS server 140 may be GSM/UMTS standard compliant by supporting messaging in RRLP format, PCAP interface and OMA SUPLv1.0. The AGPS server 140 may be configured to communicate with the location server 160 via either a user-plane or a control-plane to seamlessly connect with the location server 160.

The WWRN 150 may comprise suitable logic, circuitry and/or code that may be enabled to collect and distribute data for GPS satellites on a continuous basis. The WWRN 150 may comprise a plurality of GPS reference receivers located around the world to provide AGPS coverage all the time in both home network and visited network allowing users of GPS enabled devices such as the GPS enabled handset 110 to roam with their LBS anywhere in the world. The WWRN 150 may ensure high levels of availability, reliability, and performance.

The location server 160 may comprise suitable logic, circuitry and/or code that may enable retrieval of location information for residential as well as enterprise users. The location server 160 may be enabled to connect to the AGPS server 140 to acquire AGPS assistance data and transmit the acquired AGPS assistance data to one or more GPS enabled receivers to implement the AGPS technique. Communications among the location server 160, the AGPS server 140, and/or the one or more GPS enabled receivers may be in either user-plan or control-plan via various technologies, whether wireless or wired.

The processor 160a may be configured to use various technology specific positioning methods such as triangulation and round trip delay to retrieve and/or calculate users' locations. The processor 160a may enable converting and/or filtering technology specific reference location information such as, for example, WiFi locations, WiMAX locations, FM stations, TV antenna, and other means of identifiable location information, to their respective LAT/LON (latitude and longitude). The processor 160a may enable generation of a GPRM for the GPS enabled handset 110 based on reference location information from the GPS enabled handset 110 as well as a plurality of other devices associated with the location server 160. The formation of the GPRM for the GPS enabled handset 110 may be Cell-ID based, MCC based, MNC based, RNC based, and/or LAC based. The processor 160a may be enabled to encrypt and format the generated GPRM and download back to the GPS enabled handset 110 by using a proprietary bulk delivery mechanism, for example.

The memory 160b may comprise suitable logic, circuitry, and/or code that enable storing information such as executable instructions and data that may be utilized by the processor 160a. The executable instructions may comprise algorithms that may be enabled to calculate navigation information using the acquired satellite signals automatically or upon request/ and/or signaled. The data may comprise various LAT/LON (latitude and longitude) of a plurality communication devices associated to the location server 160. The memory 160b may comprise RAM, ROM, low latency nonvolatile memory such as flash memory and/or other suitable electronic data storage.

In operation, various technology specific reference locations, such as, for example, WiFi locations, WiMAX locations, FM stations, TV antenna, and other means of identifiable location information may be collected to be used as initial reference positions for AGPS calculation for the GPS enabled handset 110. The reference location information may be stored in a reference position database created inside the GPS enabled handset 110. The reference position database may be updated via tracking surrounding reference locations ad/or via communicating reference location information between the GPS enabled handset 110 and the location server 160. In this regard, the GPS enabled handset 110 may send a portion or the whole of the reference position database inside the GPS enabled handset 110 to the location server 160 coupled to the telecommunication network 130. The location server 160 may format the received technology specific reference location information and generate a GPRM, accordingly.

The GPRM may be generated based on the received reference location information from the GPS enabled handset 110 as well as the available reference location information from other devices associated with the location server 160. The generated GPRM may be Cell-ID based, MCC based, MNC based, RNC based, and/or LAC based, depending on the configuration of the location server 160. The generated GPRM may be communicated to the GPS enabled handset device 110 and stored in the reference position database to be used as reference positions for AGPS calculations. In instances when AGPS assistance data may be required from the GPS enabled handset device 110, the AGPS server 140 may generate AGPS assistance data from GPS satellite data and pass to the GPS enabled handset 110 in either user-plane or control-plane via the location server 160 and the telecommunication network 130. The GPS enabled handset 110 may use the received AGPS assistance data together with a plurality of GPS local measurements to determine the actual position of the GPS enabled handset 110. A fast position fix for the GPS enabled handset 110 may be achieved by combining the received AGPS assistance data and a plurality of GPS local measurements with the reference position information provided by the reference position database. In instances when LTO technology may be in use, a fast position fix may be achieved at the GPS enabled handset 110 by combining the received LTO AGPS assistance data with the reference position database even when the GPS enabled handset 110 may be temporarily out of network range.

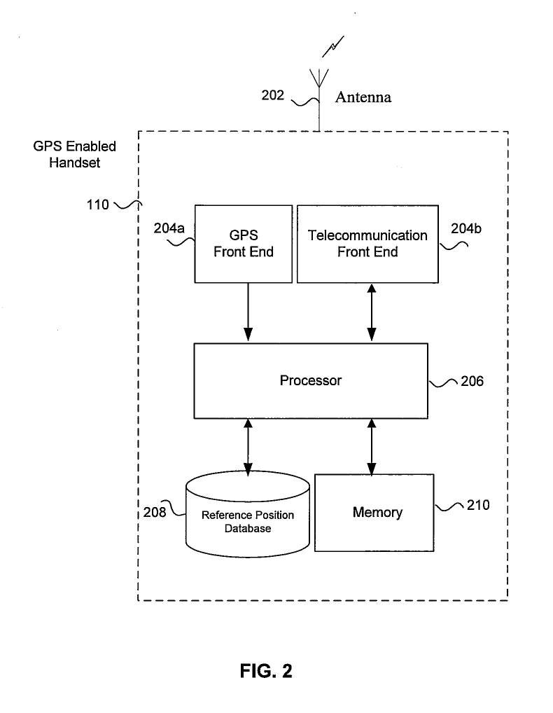

FIG. 2 is a diagram illustrating an exemplary GPS enabled handset, in accordance with an embodiment of the invention. Referring to FIG. 2, there is shown the GPS enabled handset 110 comprising an antenna 202, a GPS front end 204a, a telecommunication front end 204b, a processor 206, a reference position database 208, and a memory 210.

The antenna 202 may comprise suitable logic, circuitry and/or code that may be enabled to receive L band signals from a plurality of GPS satellites such as the GPS 120a through 120c and may be capable of transmitting and/or receiving radio signals over, for example, the Bluetooth radio communication system, for communications among Bluetooth devices.

The GPS front end 204a may comprise suitable logic, circuitry and/or code that may be enabled to receive GPS satellite broadcast signals via the antenna 202 and convert them to GPS baseband signals, which may be suitable for further processing in the processor 206 for a navigation solution, whether GPS based or AGPS based.

The telecommunication front end 204b may comprise suitable logic, circuitry and/or code that may be enabled to transmit and/or receive radio signals over a telecommunication network such as a Bluetooth network via the antenna 202 and convert them to corresponding baseband signals, which may be suitable for further processing in the processor 206.

The processor 206 may comprise suitable logic, circuitry and/or code that may be enabled to process received satellite signals as well as signals received from a telecommunication network. The processor 206 may be configured to extract navigational information from each received satellite signal to compute a position fix for the GPS enabled handset 110. The processor 206 may be programmed to calculate the position fix by combining local GPS measurements, AGPS assistance data, and the reference position database 208. When LTO AGPS assistance data may be available, the processor 206 may be enabled to calculate a position fix for the GPS enabled handset 110 based on local GPS measurements, the LTO AGPS assistance data, initial reference positions stored the reference position database 208.

The reference position database 208 may comprise suitable logic, circuitry, and/or code that may be operable to manage and store data comprising reference positions. The contents in the reference position database 208 may be used as reference positions for GPS calculations of the GPS enabled handset 110. The contents in the reference position database 208 may be updated as a needed base or periodically.

The memory 210 may comprise suitable logic, circuitry, and/or code that may enable storing of information such as executable instructions and data that may be utilized by the processor 206. The executable instructions may comprise algorithms that may be enabled to calculate a position fix using local GPS measurements, the LTO AGPS assistance data from the AGPS server 140, and reference positions provided by the reference position database 208. The data may comprise local GPS measurements and LTO AGPS assistance data. The local GPS measurements may be associated to the satellite signals directly received from the GPS satellite 120a through 120c. The LTO AGPS assistance data may be from AGPS server 140 and received through the telecommunication front end 204b via the telecommunication network 130. The memory 210 may comprise RAM, ROM, low latency nonvolatile memory such as flash memory and/or other suitable electronic data storage.

In operation, a plurality of signals may be received at the antenna 202, which is coupled to the GPS enabled handset 110. The received plurality of signals may be measured and communicated to the GPS front end 204a or the telecommunication front end 204b, respectively, depending on the type of received signals. The GPS front end 204a may convert the received GPS signals into corresponding baseband signals and pass to the processor 206. The telecommunication front end 204b may convert the received telecommunication signals into corresponding baseband signals and pass to the processor 206. The received telecommunication signals may comprise LTO AGPS assistance data from the AGPS server 140. The received LTO AGPS assistance data may be stored in the memory 210. In instances where the user of the GPS enabled handset 110 may need to calculate its position, the processor 206 may determine a position fix for the GPS enabled handset 110 based on the LTO AGPS assistance data stored in the memory 210, and the local GPS measurements from the GPS front end 204a, and initial reference positions from the reference position database 208, respectively.

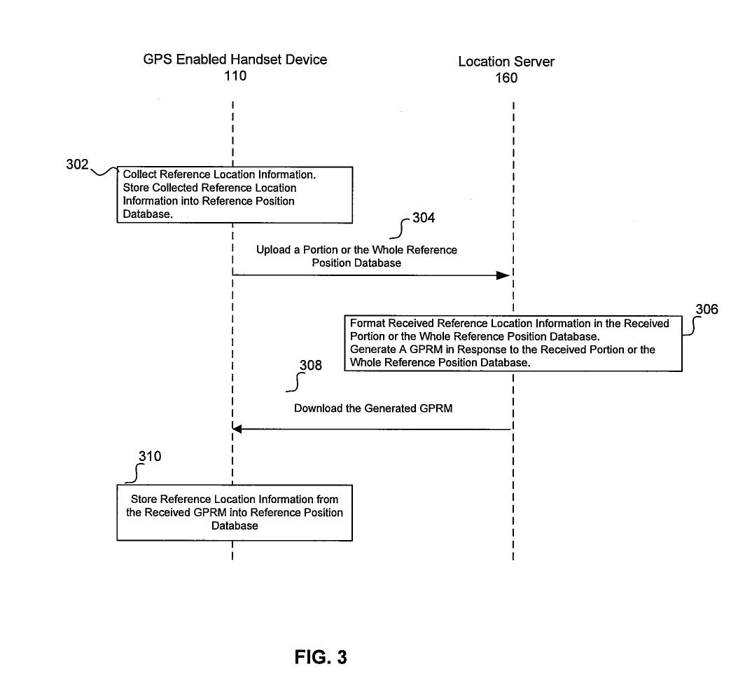

FIG. 3 is an exemplary call flow illustrating a reference position learning procedure, in accordance with an embodiment of the invention. Referring to FIG. 3, the exemplary steps may begin with step 302, where the GPS enabled handset 110 may collect reference location information such as, for example, WiFi locations, WiMAX locations, FM stations, TV antenna, and other means of identifiable location information, in current area. The collected reference location information may be stored in the reference position database 208. In step 304, the GPS enabled handset 110 may upload a portion or the whole reference position database to the location server 160 via the telecommunication network 130. In step 306, the location server 160 may format the received area location information from the reference position database 208 and generate a GPRM based on the received area location information from the GPS enabled handset 110 and available various reference location information of other devices associated to the location server 160. In instances where the GPS enabled handset 110 may request reference location information for a particular area, indicated by, for example, a Cell-ID, a RNC, a MNC, and/or a MCC combination of these different types. The location server 160 may generate a GPRM comprising reference location information in the particular area and/or associated surrounding areas, accordingly. In step 308, the location server 160 may download the generated GPRM back to the GPS enabled handset 110 in either user-plane or control-plane via the telecommunication network 130. In step 310, the GPS enabled handset 110 may store reference location information from the received GPRM into the reference position database 208.

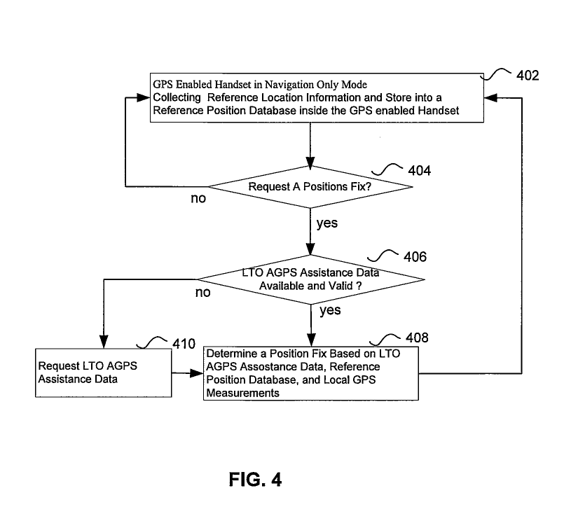

FIG. 4 is an exemplary flow chart for fast determining a position fix for a GPS enabled handset, in accordance with an embodiment of the invention. Referring to FIG. 4, the exemplary steps may begin with step 402, where the GPS enabled handset 110 may be in a navigation mode. The GPS enabled handset 110 may collect reference location information and store into the reference position database 208. In step 404, it may be determined whether there may be a request of determining a position fix for the GPS enabled handset 110. In instances where the GPS enabled handset 110 may need to determine its position fix, then in step 406, where it may be determined whether the LTO AGPS assistance data may be available and valid. In instances where the LTO AGPS assistance data may be available and valid, then in step 408, where determine a position fix for the GPS enabled handset 110 based on the LTO AGPS assistance data, reference position information from the reference position database 208, and local GPS measurements, even without a data connection to the location server 160, then the exemplary steps may return to step 402. In step 404, in instances where the GPS enabled handset 110 may not request a position fix, then the exemplary steps may return to step 402. In step 406, in instances where the LTO AGPS assistance data may not be available or valid, then in step 410, the GPS enabled handset 110 may send a LTO AGPS assistance data request to the AGPS server 140 via the location server 160. The AGPS server 140 may generate LTO AGPS assistance data and download back to the GPS enabled handset 110 via the location server 160. The exemplary steps may continue in step 408.

Aspects of a method and system for global position reference map (GPRM) for AGPS are provided. In accordance with various embodiments of the invention, a remote GPS enabled device such as the GPS enabled handset 110 may transmit reference location data to a location server such as the location server 160 coupled to the telecommunication network 130. The location server 160 may determine a global position reference map (GPRM) based on the received reference location data transmitted from the GPS enabled handset 110. In return, the GPS enabled handset 110 may receive the determined GPRM from the location server 160. The reference location data and/or the determined GPRM may comprise a plurality of reference positions for the GPS enabled handset 110. The reference positions may be determined via various ways. For example, the reference positions may comprise LAT/LON (latitude and longitude) coordinates of surrounding base stations, WiFi towers, WiMAX towers, FM stations, TV antenna, and/or other means of identifiable location information such as, for example, location information based on received GPS signals.

The reference location data may be provided and/or presented in various formats. For example, the reference location data may be formatted via various technology specific location identifiers such as a Cell-ID, a RNC ID, a MNC, and/or a MCC. The location identifiers may indicate a desired coverage area required for the determined GPRM. For instance, the location server 160 may retrieve and generate a GPRM specifically for a particular coverage area indicated by a location identifier in the received reference location data from the GPS enabled handset 110. The reference location data may be at least a portion of the reference position database 208. The reference position database 208 may be updated via storing the reference position information from the received GPRM and/or tracking regional reference location changes. As presented, for example, with respect to FIG. 4, a fast position fix for the GPS enabled handset 110 may be determined based on AGPS data or LTO AGPS data, and the reference position database 208. The position fix for the GPS enabled handset 110 may be achieved based on LTO AGPS data and the reference position database 208 even without a network connection.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for a method and system for global position reference map (GPRM) for AGPS.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method of processing signals, the method comprising:
transmitting reference location data from a GPS enabled device to a location server, wherein said location server determines a global position reference map (GPRM) based on said transmitted reference location data; and
receiving from said location server, said determined global position reference map by said GPS enabled device.

2. The method according to claim 1, wherein said reference location data and/or said determined global position reference map (GPRM) comprises one or more reference positions.

3. The method according to claim 1, comprising determining said reference location data from surrounding base stations, WiFi towers, WiMAX towers, FM stations, and/or TV antenna.

4. The method according to claim 1, comprising determining said reference location data based on satellite data received by said GPS enabled device.

5. The method according to claim 1, wherein said reference location data comprises a location identifier that indicates a coverage area of said determined global position reference map (GPRM).

6. The method according to claim 5, wherein said location server generates said global position reference map (GPRM) based on said location identifier.

7. The method according to claim 1, wherein said reference location data and/or said determined global position reference map (GPRM) is Cell-ID based, RNC (Radio Network Controller) based, MNC (Mobile Network Code) based, and/or MCC (Mobile Country Code) based.

8. The method according to claim 1, wherein at least a portion of said transmitted reference location data is stored within said GPS enabled device.

9. The method according to claim 8, comprising updating said reference location data stored within said GPS enabled device based on said received global position reference map (GPRM).

10. The method according to claim 1, comprising determining a position fix for said GPS enabled device based on AGPS data or long term orbits (LTO) AGPS data, said reference location data and/or said received global position reference map (GPRM).

11. The method according to claim 10, comprising determining said position fix for said GPS enabled device based on said long term orbits (LTO) AGPS data, said reference location data and/or said received global position reference map (GPRM), without a network connection.

12. A system for processing signals, the system comprising:
one or more processors operable to transmit reference location data from a GPS enabled device to a location server, wherein said location server determines a global position reference map (GPRM) based on said transmitted reference location data; and
said one or more processors are operable to receive from said location server, said determined global position reference map (GPRM) by said GPS enabled device.

13. The system according to claim 12, wherein said reference location data and/or said determined global position reference map (GPRM) comprises one or more reference positions.

14. The system according to claim 12, wherein said one or more processors are operable to determine said reference location data from surrounding base stations, WiFi towers, WiMAX towers, FM stations, and/or TV antenna.

15. The system according to claim 12, wherein said one or more processors are operable to determine said reference location data based on satellite data received by said GPS enabled device.

16. The system according to claim 12, wherein said reference location data comprises a location identifier that indicates a coverage area of said determined global position reference map (GPRM).

17. The system according to claim 16, wherein said location server generates said global position reference map (GPRM) based on said location identifier.

18. The system according to claim 12, wherein said reference location data and/or said determined global position reference map (GPRM) is Cell-ID based, RNC (Radio Network Controller) based, MNC (Mobile Network Code) based, and/or MCC (Mobile Country Code) based.

19. The system according to claim 12, wherein at least a portion of said transmitted reference location data is stored within said GPS enabled device.

20. The system according to claim 19, wherein said one or more processors are operable to update said reference location data stored within said GPS enabled device based on said received global position reference map (GPRM).

21. The system according to claim 12, wherein said one or more processors are operable to determine a position fix for said GPS enabled device based on AGPS data or long term orbits (LTO) AGPS data, said reference location data and/or said received global position reference map (GPRM).

22. The system according to claim 21, wherein said one or more processors are operable to determine said position fix for said GPS enabled device based on long term orbits (LTO) AGPS data, said reference location data and/or said received global position reference map (GPRM), without a network connection.
